(19) United States
(12) Patent Application Publication
(10) Pub. No.: US 2022/0270286 A1
(43) Pub. Date: Aug. 25, 2022

(54) SYSTEM, LOCATION INFORMATION MANAGEMENT APPARATUS, LOCATION SPECIFYING METHOD, AND PROGRAM

(71) Applicant: NEC Corporation, Minato-ku, Tokyo (JP)

(72) Inventor: Shinya YASUDA, Tokyo (JP)

(73) Assignee: NEC Corporation, Minato-ku, Tokyo (JP)

(21) Appl. No.: 17/632,876

(22) PCT Filed: Jul. 21, 2020
(86) PCT No.: PCT/JP2020/028202

§ 371 Date: Feb. 4, 2022

(30) Foreign Application Priority Data
Aug. 26, 2019 (JP) 2019-153966

(51) Int. Cl. G06T 7/73; G06T 5/00; G06T 5/20; G06T 7/215

(52) U.S. Cl. CPC G06T 7/73; G06T 5/002; G06T 5/20; G06T 7/215

(57) ABSTRACT

In order to provide system accurately identifying a moving object, the system includes a moving object and a location information management apparatus. The moving object is equipped with a top panel on which a light emitting part is disposed. The location information management apparatus extracts a first image including the light emitting part from an image in which the moving object is captured, executes image processing on the first image to detect a presence of the moving object, and specifies a location of the moving object. The image processing may be processing for removing noise included in a region corresponding to the light emitting part of the first image.

### BACKGROUND

### Technical Field

The present invention relates to a system, a location information management apparatus, a location specifying method, and a program.

### Background Art

In a production site such as a factory, it is necessary to move articles such as components and materials to be used. The moving of articles is necessary also in a distribution warehouse. A transfer robot (automated guided vehicle (AGV)) is used for moving the articles.

PTL 1 describes that an LIBS-type object sorting apparatus is provided in which laser-induced breakdown spectroscopy (LIBS) analysis is carried out while transferring object to be sorted using a conveyor, and sorting is performed on the basis of the analysis. PTL 1 discloses a technique for irradiating a target object transferred on the conveyor with laser light, and analyzing wavelength of a reflected light of the laser light to sort the target object. In the technique disclosed in PTL 1, a camera is used to specify a location of the target object, and the target object is irradiated with the laser to adjust a drop location of the object.

PTL 2 describes that a location and posture of a moving object moving on a movement surface with low contrast and a shape of the movement surface are detected under an environment with low illuminance. In PTL 2, point light sources are provided on an upper portion of the moving object, and the light sources are used as markers for detecting the location and the posture. In the technique disclosed in PTL 2, a stereo camera is used to capture an image of the moving object, and a range sensor is used to remove unnecessary objects such as a wall surface and a cable.

PTL 3 describes that a mobile body location detecting system is achieved that is capable of easily recognizing a location and posture of a mobile body such as a robot. In PTL 3, locations of light-emitting elements captured on a camera are specified, and the locations of the light-emitting elements are converted from a camera coordinate system to an absolute coordinate system to specify the location of the mobile body. In PTL 3, a plurality of light-emitting elements are arranged on the mobile body (the moving object) to specify coordinates of the object or identify the object on the basis of light-emitting patterns specific to the plurality of light-emitting elements.

### CITATION LIST

### Patent Literature

### [PTL 1] WO 2018/012346

### [PTL 2] JP 2013-024735 A

### [PTL 3] WO 2002/023122

### SUMMARY

### Technical Problem

As described above, a robot (transfer robot) may be used to transfer an article. Here, it can be thought that a form of article transfer by the transfer robot includes a type in which the transfer robot autonomously moves on a transfer path, and a type in which a control apparatus communicating with the transfer robot remotely controls the transfer robot.

In the latter case, the control apparatus is required to grasp the location of the transfer robot. At this time, as disclosed in PTL 2 or PTL 3, a light source (light-emitting element) is considered to be used. Specifically, a light source is provided to a top panel or the like of the transfer robot, and a camera apparatus attached to a ceiling captures an image of the transfer robot. The control apparatus acquires image data from the camera apparatus, and analyzes the image data to calculate a location of the transfer robot.

For example, the control apparatus is required to identify the transfer robots holding an article from the image data, and specify the location. At this time, the control apparatus may not identify (extract) the transfer robot from the image data depending on a positional relationship between the article to be transferred or a cart loaded with the article and a camera.

For example, as illustrated in FIG. 21, if a height of the article to be transferred (or the cart loaded with the article) is not so high, the top panel of the transfer robot can be within a field of view of the camera. In contrast, as illustrated in FIG. 22, if the height of the article to be transferred is high, the field of view of the camera may be obstructed by the article, and thus, only a part of the transfer robot may be captured in the image data.

Specifically, in such a case that a basket cart is loaded with an article, and the transfer robot transfers the basket cart with the article, a frame of the basket cart hides a part of the top panel of the transfer robot. In the image data captured in such a situation, the top panel of the robot is divided into a plurality of regions, and the control apparatus cannot correctly recognize the transfer robot.

The present invention has a main example object to provide a system, a location information management apparatus, a location specifying method, and a program that contribute to accurately identifying a moving object.

### Solution to Problem

According to a first example aspect of the present invention, there is provided a system including a moving object equipped with a top panel on which a light emitting part is disposed; and a location information management apparatus configured to extract a first image including the light emitting part from an image in which the moving object is captured, execute image processing on the first image to detect a presence of the moving object, and specify a location of the moving object.

According to a second example aspect of the present invention, there is provided a location information management apparatus configured to extract, from an image in which a moving object is captured, the moving object being equipped with a top panel on which a light emitting part is disposed, a first image including the light emitting part, execute image processing on the first image to detect a presence of the moving object, and specify a location of the moving object.

According to a third example aspect of the present invention, there is provided a location specifying method in a location information management apparatus, the location specifying method including: extracting, from an image in which a moving object is captured, the moving object being equipped with a top panel on which a light emitting part is disposed, a first image including the light emitting part; executing image processing on the first image to detect a presence of the moving object; and specifying a location of the moving object.

According to a fourth example aspect of the present invention, there is provided a program causing a computer mounted on a location information management apparatus to execute: extracting, from an image in which a moving object is captured, the moving object being equipped with a top panel on which a light emitting part is disposed, a first image including the light emitting part; executing image processing on the first image to detect a presence of the moving object; and specifying a location of the moving object.

According to a fifth example aspect of the present invention, there is provided a system including: a moving object equipped with a light emitting part; a camera apparatus configured to capture an image of a field including the moving object; and a location information management apparatus configured to calculate a location of the moving object in the field by using an image acquired from the camera apparatus. The location information management apparatus is configured to extract a high brightness image including at least one or more high brightness regions, the high brightness region being a set of pixels, each pixel having a brightness value equal to or more than a prescribed value among a plurality of pixels constituting the image acquired from camera apparatus, execute image processing on the high brightness image, and determine whether the moving object is included in the image acquired from the camera apparatus in accordance with an area of the high brightness region included in the image after executing the image processing.

### Advantageous Effects of Invention

According to example aspects of the present invention, there are provided a system, a location information management apparatus, a location specifying method, and a program that contribute to accurately identifying a moving object. Note that, according to the present invention, instead of or together with the above effects, other effects may be exerted.

### BRIEF DESCRIPTION OF THE DRAWINGS

FIG. 1 is a diagram for describing an overview of an example embodiment;

FIG. 2 is sequence diagram illustrating an example of an operation of a location information management apparatus according to an example embodiment;

FIG. 3 is a diagram illustrating an example of a schematic configuration of a transfer system according to a first example embodiment;

FIG. 4 is a diagram illustrating an example of a processing configuration of a transfer robot according to the first example embodiment;

FIG. 5 is a diagram illustrating an example of a processing configuration of a location information management apparatus according to the first example embodiment;

FIG. 6 is a diagram illustrating an example of a processing configuration of a location information generation section according to the first example embodiment;

FIG. 7 is a diagram illustrating an example of image data acquired by the location information generation section;

FIG. 8 is a diagram illustrating an example of a high brightness image extracted;

FIG. 9 is a diagram illustrating an example of a high brightness image extracted;

FIG. 10A is a diagram for describing closing processing;

FIG. 10B is a diagram for describing the closing processing;

FIG. 10C is a diagram for describing the closing processing;

FIG. 11A is a diagram for describing the closing processing;

FIG. 11B is a diagram for describing the closing processing;

FIG. 11C is a diagram for describing the closing processing;

FIG. 12 is a diagram for describing the closing processing;

FIG. 13 is a flowchart illustrating an example of an operation of a robot detection section according to the first example embodiment;

FIG. 14A is a diagram for describing an operation of the robot detection section;

FIG. 14B is a diagram for describing an operation of the robot detection section;

FIG. 14C is a diagram for describing an operation of the robot detection section;

FIG. 15 is a diagram illustrating an example of robot location information transmitted from the location information management apparatus;

FIG. 16 is a diagram illustrating an example of a screen displayed by a terminal according to the first example embodiment;

FIG. 17 is a diagram illustrating an example of a processing configuration of a control apparatus according to the first example embodiment;

FIG. 18 a diagram for describing an operation of a robot detection section according to a second example embodiment;

FIG. 19 is a flowchart illustrating an example of an operation of the robot detection section according to the second example embodiment;

FIG. 20 is a diagram illustrating an example of a hardware configuration of the location information management apparatus;

FIG. 21 is a diagram for describing a relationship between the transfer robot and a camera apparatus; and

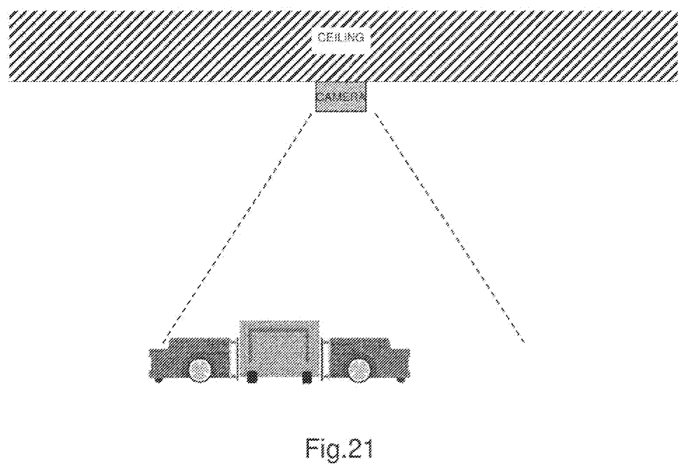

FIG. 22 is a diagram for describing a relationship between the transfer robot the camera apparatus.

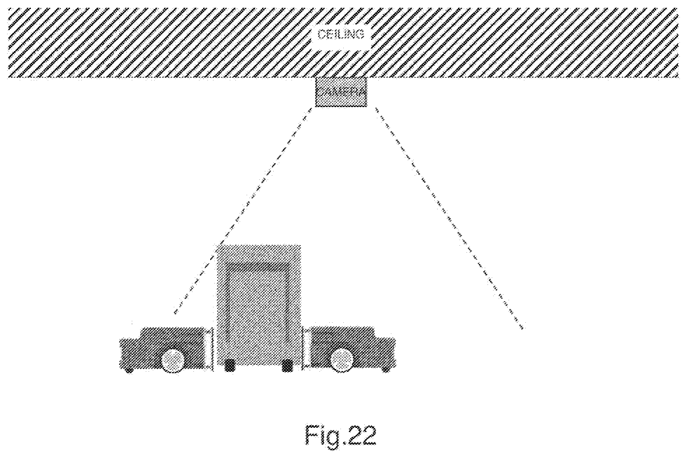

### DESCRIPTION OF THE EXAMPLE EMBODIMENTS

First of all, an overview of an example embodiment will be described. Note that reference signs in the drawings provided in the overview are for the sake of convenience for each element as an example to promote better understanding, and description of the overview is not to impose any limitations. Note that, in the Specification and drawings, elements to which similar descriptions are applicable are denoted by the same reference signs, and overlapping descriptions may hence be omitted.

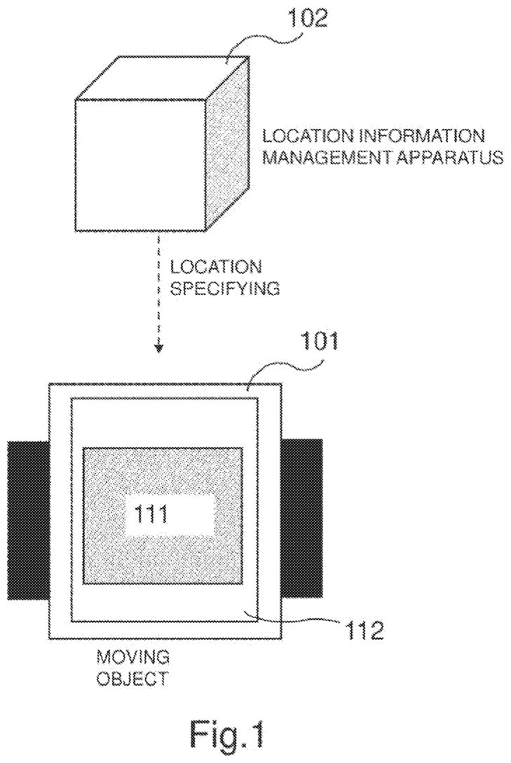

A system according to an example embodiment includes a moving object 101 and a location information management apparatus 102 (see FIG. 1). The moving object 101 is equipped with a top panel 112 on which a light emitting part 111 is disposed. The location information management apparatus 102 extracts a first image including the light emitting part 111 from an image in which the moving object 101 is captured. The location information management apparatus 102 executes image processing on the first image to detect a presence of the moving object 101 and specify a location of the moving object 101.

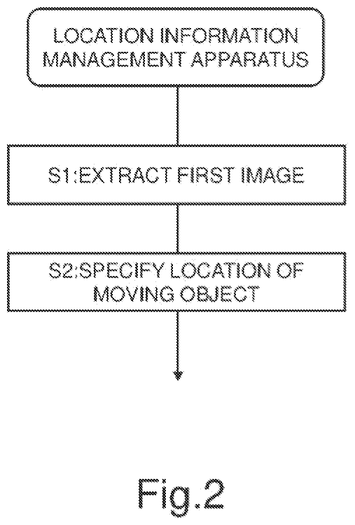

The operation of the location information management apparatus 102 according to an example embodiment is summarized as in FIG. 2. The location information management apparatus 102 extracts the first image including the light emitting part 111 from the image in which the moving object 101 is captured (step S1). The location information management apparatus 102 executes the image processing on the first image to detect a presence of the moving object 101 and specify a location of the moving object 101 (step S2).

A location information management apparatus 30 executes image processing, particularly, noise removing processing such as closing processing on an image data in which the moving object 101 to be detected is included to make clear a region corresponding to the light emitting part 111 in the image data. The location information management apparatus 30 performs detection processing of the moving object 101 by using the image after the image processing being performed, and thus, can accurately identify the moving object such as the transfer robot.

Hereinafter, specific example embodiments are described in more detail with reference to the drawings.

### First Example Embodiment

The first example embodiment will be described in further detail with reference to the drawings.

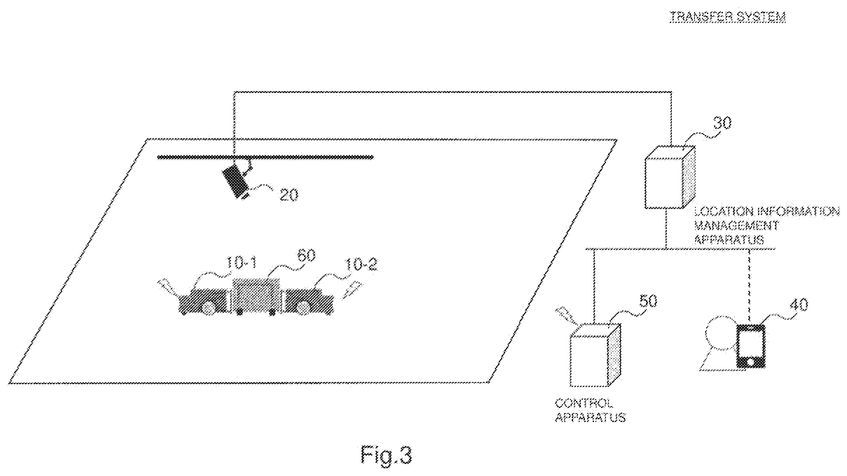

FIG. 3 is a diagram illustrating an example of a schematic configuration of a transfer system according to the first example embodiment. With reference to FIG. 3, the transfer system is configured to include a plurality of transfer robots 10-1 and 10-2, a camera apparatus 20, the location information management apparatus 30, a terminal 40, and the control apparatus 50.

In the following description, the transfer robots 10-1 and 10-2, in a case of no special reason for being distinguished, are merely expressed as the “transfer robot 10”. Other configurations are also expressed similarly. The configuration illustrated in FIG. 2 is an example, and is not intended to limit the number of camera apparatuses 20 or the like included in the transfer system. For example, a plurality of camera apparatuses 20 may be included in the system. For example, the image data captured by the plurality of camera apparatuses 20 may cover an entire field.

The transfer robot 10 is a robot transferring an article 60. In the first example embodiment, the transfer robot 10 is a cooperative transfer robot that transfers the article 60 in cooperation with another robot. Two transfer robots 10 hold the article 60 therebetween in opposite directions, and move in a state of holding the article 60 to transfer the article 60. The transfer robot 10 is configured to be communicable with the control apparatus 50, and moves on the basis of a control command (control information) from the control apparatus 50.

Note that the transfer robot 10 has a top panel at which a light source such as a light emitting diode (LED) is attached. A region (high bright region) lighting by the light source (light emitting part) disposed at the top panel of the transfer robot 10 is used to identify the transfer robot 10 and calculate a location of the transfer robot 10. For example, two transfer robots 10 can be identified by differentiating an area of the top panel of the transfer robot 10-1 from an area of the top panel of the transfer robot 10-2, the both transfer robots being provided with the light source (light emitting part).

Note that the article 60 is fixed to a wheeled cart. Therefore, when two transfer robots 10 lightly holds the article 60 therebetween and moves, the article 60 also moves. Note that in the following description, a pair consisting of two transfer robots 10 is referred to as a transfer robot pair.

The camera apparatus 20 is an apparatus capturing images in a field. For example, the camera apparatus 20 includes a camera capable of calculating a distance between the camera and an object, such as a stereo camera. The camera apparatus 20 is attached at a ceiling, a post, the like. The camera apparatus 20 is connected with the location information management apparatus 30. The camera apparatus 20 captures images in the field at a prescribed interval (or a prescribed sampling period), and transmits image data to the location information management apparatus 30. The camera apparatus 20 captures images of a circumstance in the field in real time, and transmits the image data including the circumstance in the field to the location information management apparatus 30.

The location information management apparatus 30 is an apparatus performing management relating to a location of an object in the field (for example, a factory or a distribution warehouse). The location information management apparatus 30 is an apparatus that extracts a first image including the light emitting part (light source) from an image in which a moving object (transfer robot 10) is captured, and executes image processing on the first image to detect a presence of the moving object and specify a location of the moving object.

The location information management apparatus 30 identifies the moving object (transfer robot 10) locating in the field on the basis of the image data received from the camera apparatus 20, and generates location information of the moving object. For example, in the example in FIG. 3, the location information management apparatus 30 generates the location information of the transfer robot 10-1 and the location information of the transfer robot 10-2.

The location information management apparatus 30 calculates the location (absolute position) of transfer robot 10 in a coordinate system (X-axis, Y-axis) with an origin at any one point in the field (for example, a doorway). The location information management apparatus 30 transmits the calculated location information of the transfer robot 10 (hereinafter, referred to as the robot location information) to the control apparatus 50.

The terminal 40 is a terminal used by an operator. Examples of the terminal 40 include a mobile terminal apparatus such as a smartphone, a mobile phone, a gaming console, and a tablet, and a computer (a personal computer, a notebook computer). However, the terminal 40 is not intended to be limited to these examples. The terminal 40 inputs information relating to transfer of the article 60 from the operator. Specifically, the terminal 40 displays an operation screen (graphical user interface (GUI)) to input a transfer source and a transfer destination from and to which the transfer robot pair transfers the article 60. The terminal 40 generates article transfer plan information including information relating to an article to be transferred, and the transfer source and transfer destination of the article to be transferred on the basis of the information input by the operator. The terminal 40 transmits the generated article transfer plan information to the control apparatus 50.

The control apparatus 50 is an apparatus remotely controlling the transfer robot 10. Specifically, the control apparatus 50 uses the robot location information acquired from the location information management apparatus 30 and the article transfer plan information acquired from the terminal 40 to control the transfer robot 10.

The control apparatus 50 transmits the control command to each of two transfer robots 10 to perform remote control such that the transfer robot pair moves to the transfer destination of the article 60. At this time, the control apparatus 50 perform the remote control such that the transfer robot pair moves to the transfer destination in a state of holding the article 60 therebetween. For example, the control apparatus 50 transmits the control command (control information) such that two opposite transfer robots 10 moves while keeping a distance between two transfer robots 10 facing each other.

Subsequently, each apparatus included in the transfer system is described in detail.

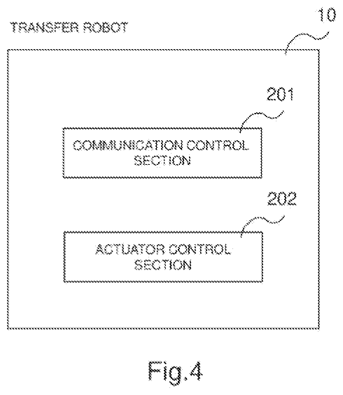

FIG. 4 is a diagram illustrating an example of a processing configuration (processing module) of the transfer robot 10 according to the first example embodiment. With reference to FIG. 4, the transfer robot 10 is configured to include a communication control section 201 and an actuator control section 202.

The communication control section 201 is means for controlling communication with the control apparatus 50. The communication control section 201 uses a radio communication means such as a wireless local area network (LAN), Long Term Evolution (LTE), and a network used in a specific area like local 5G to communicate with the control apparatus 50.

The actuator control section 202 is means for controlling an actuator including a motor or the like on the basis of the control command (control information) received from the control apparatus 50. For example, the control apparatus 50 transmits a control command including a rotation start of the motor, a rotation speed of the motor, a rotation stop of the motor, and the like to the transfer robot 10. The actuator control section 202 controls the motor or the like in accordance with the control command.

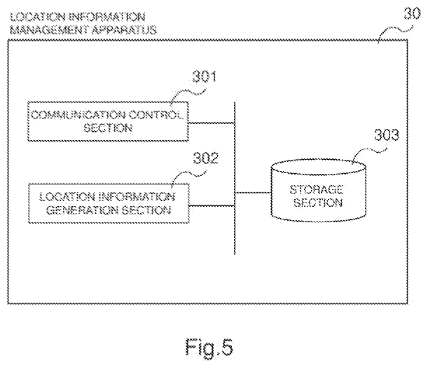

FIG. 5 is a diagram illustrating an example of a processing configuration (processing module) of the location information management apparatus 30 according to the first example embodiment. With reference to FIG. 5, the location information management apparatus 30 is configured to include a communication control section 301, a location information generation section 302, and a storage section 303.

The communication control section 301 is means for controlling communication with another apparatus (for example, the camera apparatus 20, the control apparatus 50) connected therewith in a wired (for example, LAN, optical fiber, or the like) or wireless manner.

The location information generation section 302 is means for generating the robot location information described above. The location information generation section 302 generates the robot location information on the basis of the image data acquired from the camera apparatus 20.

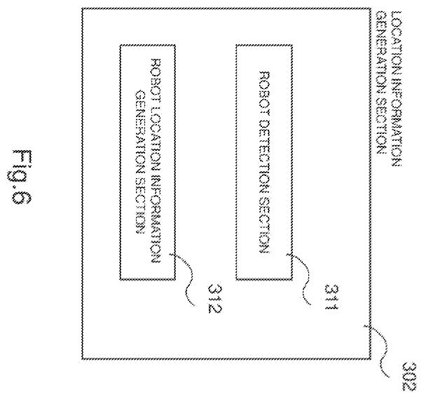

FIG. 6 is a diagram illustrating an example of a processing configuration of the location information generation section 302. As illustrated in FIG. 6, the location information generation section 302 includes a submodule including a robot detection section 311 and a robot location information generation section 312.

The robot detection section 311 is means for detecting the transfer robot 10 from the image data acquired from the camera apparatus 20.

The robot detection section 311 extracts an image including a region of a pixel having a brightness higher than a prescribed value in pixels constituting the image data acquired from the camera apparatus 20. Note that in the following description, the pixel having the brightness higher than the prescribed threshold is referred to as the “high brightness pixel”. The region consisting of the high brightness pixels is referred to as a “high brightness region”. An image including at least one or more high brightness regions is referred to as a “high brightness image”.

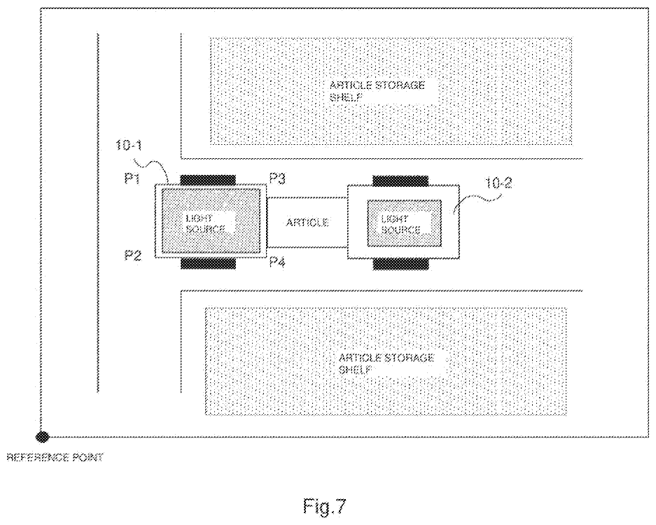

For example, assume a case that the location information generation section 302 acquires the image data as illustrated in FIG. 7. As described above, the light source is attached on the top panel of the transfer robot 10. The light source attached to top panel of the transfer robot 10 emits a light to cause a brightness of a region corresponding to the top panel to be higher than the prescribed threshold. As a result, the region corresponding to the top panel of the transfer robot 10 is extracted by the robot detection section 311.

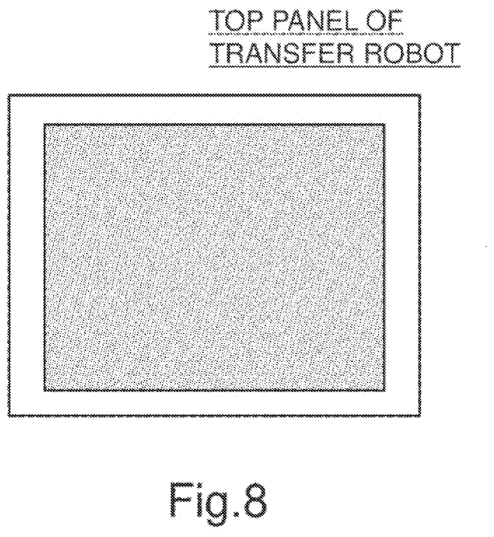

For example, in the example illustrated in FIG. 7, an image as illustrated in FIG. 8 (high brightness image) is extracted. Note that an upper limit of an area (size) of the high brightness region that is cut out from the image data by the robot detection section 311 is predefined. Specifically, the upper limit is defined in consideration of a size of the top panel of the transfer robot 10 or the like. For this reason, in the example in FIG. 7, any image including both a region corresponding to the top panel of the transfer robot 10-1 and a region corresponding to the top panel of the transfer robot 10-2 is not extracted as a high brightness image. The robot detection section 311 extracts an image including the region corresponding to the top panel of each of the transfer robot 10-1 and the transfer robot 10-2 as a “high brightness image”.

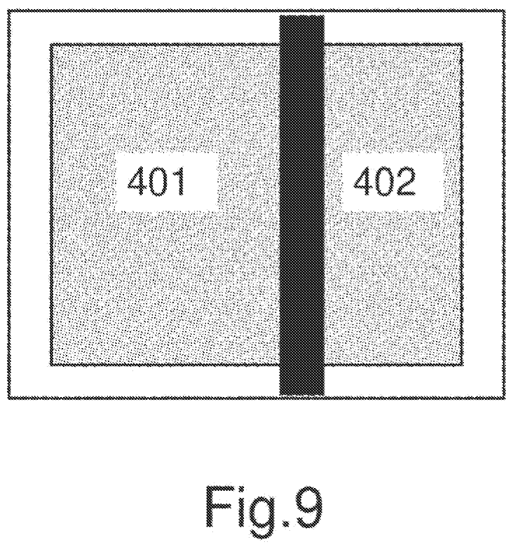

Here, as described above, when the basket cart or the like loaded with the article 60 is short in height, frames or the like of the basket cart does not overlap the top panel of the transfer robot 10 in the captured image. However, the basket cart or liked load with the article 60 may be tall, where the frame thereof may overlap the top panel of the transfer robot 10-1 in the captured image. In this case, the robot detection section 311 extracts a high brightness image as illustrated in FIG. 9.

As described above, the upper limit of the area of the high brightness region possibly included in the high brightness image is predefined. In other words, in a case that the upper limit is not reached, the robot detection section 311 extracts one high brightness image including a plurality of high brightness regions. Specifically, as illustrated in FIG. 9, in a case that the region of the top panel of the transfer robot 10 is separated by the frames or the like, an image containing two separated high brightness regions is extracted.

Alternatively, instead of defining the upper limit of the area of the high brightness region possibly included in the high brightness image, an upper limit may be given on a distance from one high brightness region to another high brightness region. For example, as illustrated in FIG. 9, even in a case that the top panel of the transfer robot 10 is separated by the frames or the like of the cart, when a distance between a region 401 and a region 402 is short, one high brightness image including two high brightness regions (region 401, 402) is extracted.

As described above, the robot detection section 311 extracts a high brightness image including at least one or more high brightness regions each of which is a set of pixels having brightness values equal to or more than the prescribed value among a plurality of pixels constituting the acquired image.

Note that the robot detection section 311 also calculates a location of the high brightness image extracted from the image data. For example, the robot detection section 311 uses a reference point as a specific place in the image data acquired from the camera apparatus 20 (for example, one lower left point) to calculate four coordinates forming the high brightness image with respect to the reference point (number of pixels with respect to the reference point). In the example in FIG. 7, coordinates P1 to P4 are calculated.

The robot detection section 311 calculates the area of the high brightness region in the high brightness image. Specifically, the robot detection section 311 counts the number of high brightness pixels constituting each high brightness region. Next, the robot detection section 311 calculates a distance from the camera apparatus 20 to the target object (the top panel of the transfer robot 10). Specifically, the robot detection section 311 calculates the distance by use of information such as a distance between lenses of a stereo camera configuring the camera apparatus 20, and a focal length. Note that the distance calculation by use of the image data captured by the stereo camera is obvious to those of ordinary skill in the art, and thus, a detailed description thereof is omitted.

The robot detection section 311 converts the number of high brightness pixels constituting the high brightness region to an area of the high brightness region on the basis of the calculated distance. In a case that an image of the transfer robot 10 is captured at a location away from the camera apparatus 20, the number of high brightness pixels is small, and thus, an area for one pixel is converted larger to calculate the area of the high brightness region.

In contrast, in a case that an image of the transfer robot 10 is captured near the camera apparatus 20, the number of high brightness pixels is large, and thus, an area for one pixel is converted smaller to calculate the area of the high brightness region. Note that an equation for conversion between the number of pixels and the area can be predefined in accordance with a distance between the transfer robot 10 and the camera apparatus 20, an actually-measured value of the number of pixels, the size of the top panel of the transfer robot 10, and the like.

In the example in FIG. 9, the robot detection section 311 calculates the areas of the region 401 and the region 402 to calculate a sum of these areas as the area of the high brightness region.

Next, the robot detection section 311 determines whether or not the calculated area falls within a predefined range. For example, assume that in identifying as the transfer robot 10-1, a lower limit of the area of the top panel is Amin 1 and an upper limit of the area of the top panel is Amax 1. In this case, a robot determination section 3012 determines whether or not the calculated area A meets a relationship “Amin1≤A≤Amax1”.

In a case that the calculated area A meets the relationship expression, the robot detection section 311 determines that the extracted high brightness image corresponds to the top panel of the transfer robot 10-1. In other words, the robot detection section 311 detects a presence of the transfer robot 10-1.

In contrast, in a case that the calculated area A does not meet the relationship expression, the robot detection section 311 executes prescribed image processing on the extracted image. In particular, in a case that the calculated area A is smaller than the lower limit Amin 1 of a predefined range, the robot detection section 311 executes the above-described image processing.

Note that in a case that the calculated area A is larger than the upper limit Amax 1 of the predefined range, the robot detection section 311 determines that the extracted high brightness image does not correspond to the top panel of the transfer robot 10-1.

In the following description, the predefined range for the robot determination is referred to as the “robot determination range”.

In a case that the calculated area is smaller than the lower limit of the robot determination range, the robot detection section 311 executes prescribed image processing on the extracted high brightness image. The prescribed image processing is processing for removing noise included in a region corresponding to the light source (the light emitting part) of the high brightness image. The first example embodiment describes a case of using the image processing called “closing”.

The closing processing is image processing executing dilation processing, and thereafter, erosion processing, the dilation processing for replacing a brightness value of the vicinity of a pixel of interest with a brightness value of the pixel of interest, the erosion processing for replacing the brightness value of the pixel of interest with use of the brightness value of vicinity of the pixel of interest.

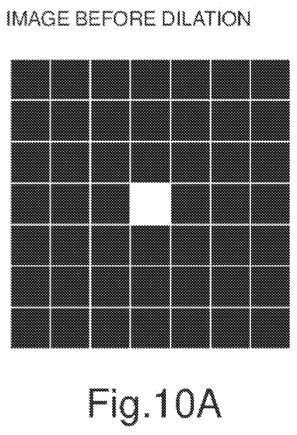

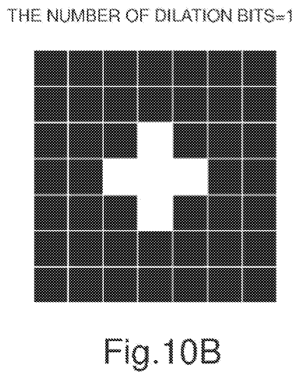

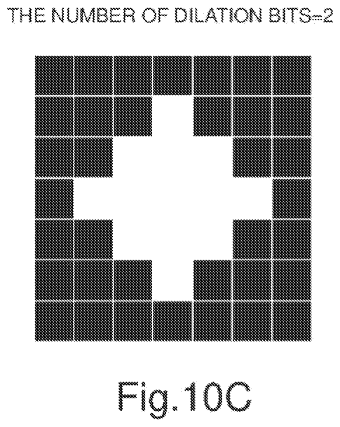

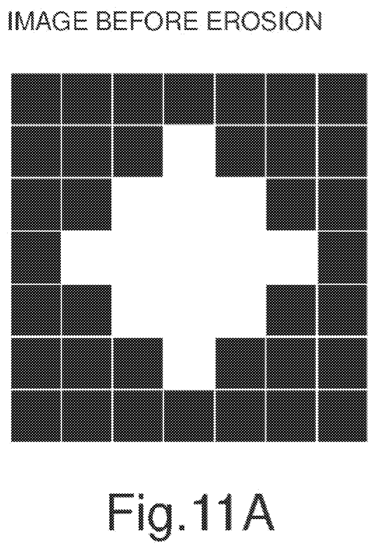

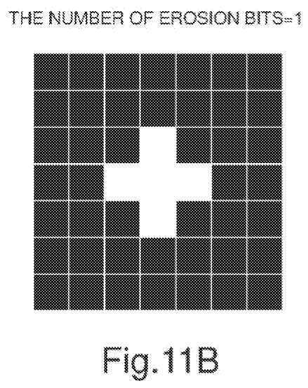

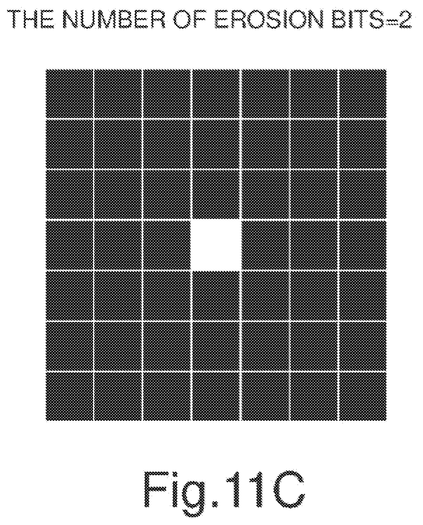

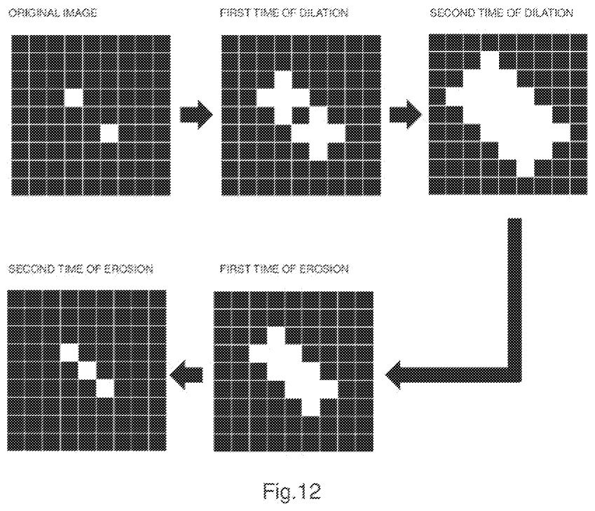

For example, the dilation processing is executed on an image illustrated in FIG. 10A to obtain an image illustrated in FIG. 10B or FIG. 10C. Note that in FIG. 10A to FIG. 10C, FIG. 11A to FIG. 11C, and FIG. 12, one cell in the figure expresses one pixel. In FIG. 10A to FIG. 10C, FIG. 11A to FIG. 11C, and FIG. 12 for describing the closing processing, the image is binarized in the illustration for easy understanding.

Note that in the dilation processing and the erosion processing included in the closing processing, the number of dilated bits (hereinafter, referred to as the number of dilation bits) and the number of eroded bits (hereinafter, referred to as the number of erosion bits) can be input as parameters.

For example, when the number of dilation bits is set to “1”, a brightness value of each of pixels located on the left, right, top and bottom of the pixel of interest is replaced with a brightness value of the pixel of interest (see FIG. 10B). Similarly, when the number of dilation bits is set to “2”, a brightness value of each of pixels located within two pixels away from the pixel of interest is replaced with the brightness value of the pixel of interest (see FIG. 10C).

The erosion processing is executed on an image illustrated in FIG. 11A to obtain an image illustrated in FIG. 11B or FIG. 11C. For example, as illustrated in FIG. 11B, when the number of erosion bits is set to “1”, the brightness value of the pixel of interest is replaced with use of brightness values of respective pixels located on the left, right, top and bottom of the pixel of interest. Similarly, when the number of erosion bits is set to “2”, the brightness value of the pixel of interest is replaced with use of brightness values of the pixels located within a range two pixels away from the pixel of interest (see FIG. 11C).

In the closing processing, the dilation processing is executed on the target image, and thereafter, the erosion processing is executed on the target image, allowing the noise contained in an original image to be removed, or disconnected figures to be joined.

In the closing processing, the number of times of each of the dilation processing and the erosion processing is not limited to one, and a plurality of times of the dilation processing, and thereafter, the same number of times of the erosion processing can be performed. For example, the dilation processing may be continuously executed twice on the original image, and the same number of times of the erosion processing may be executed on the image result from the dilation processing. The execution of the dilation processing and erosion processing plural times like this can improve a noise removal capability or the like.

In other words, in the closing processing, the number of times for iterating the dilation processing and the erosion processing can be also input as the parameters. For example, when the number of dilation bits is fixed to “1” and two times of the dilation processing are executed on an original image illustrated on the upper left in FIG. 12, an image illustrated on the upper right in the same figure is obtained. When the number of erosion bits is fixed to “1” and two times of the erosion processing are executed on the obtained image, an image illustrated on the lower left in FIG. 12 is obtained. As illustrated in FIG. 12, it is found that two times of the dilation processing and erosion processing allow high brightness regions to be linked. When a region (black region) sandwiched between two high brightness regions is taken as noise, it can be said that the noise is removed through the closing processing.

Note that although FIG. 12 illustrates the case that the number of dilation bits and the number of erosion bits are set to “1”, even if the number of dilation bits and the number of erosion bits are set to “2” and one time of the dilation processing and erosion processing is executed, the image illustrated on the lower left in FIG. 12 can be obtained. In other words, in the closing processing, the number of dilation bits and the number of erosion bits can be treated to be equivalent to the iteration number of the dilation processing and the erosion processing.

As is obvious from FIG. 12, as the number of bits or the iteration number is changed, the noise removal capability changes. One time of the dilation and erosion processing (the number of dilation bits and the number of erosion bits are “1”) does not remove the noise (black region) sandwiched between two high regions. However, that noise can be removed by two times of the dilation and erosion processing. Therefore, the number of dilation bits (the number of erosion bits) and the iteration number function as parameters to define an intensity of the closing processing. In the following description, the number of dilation bits or the iteration number may be represented by as the “intensity parameter”.

The robot detection section 311 varies the parameter defining the noise removal capability by the image processing, and calculates an area of the high brightness region (the region corresponding to the light source) included in the high brightness image for each varied parameter. The robot detection section 311 detects a presence of the transfer robot 10 on the basis of the calculated area.

Specifically, the robot detection section 311 executes the closing processing on the extracted image (the high brightness image including the high brightness region) while varying the intensity parameter defining the intensity of the closing processing. The robot detection section 311 calculates the area of the high brightness region included in the high brightness image acquired per closing processing, and determines whether or not the calculated area is included in the robot determination range.

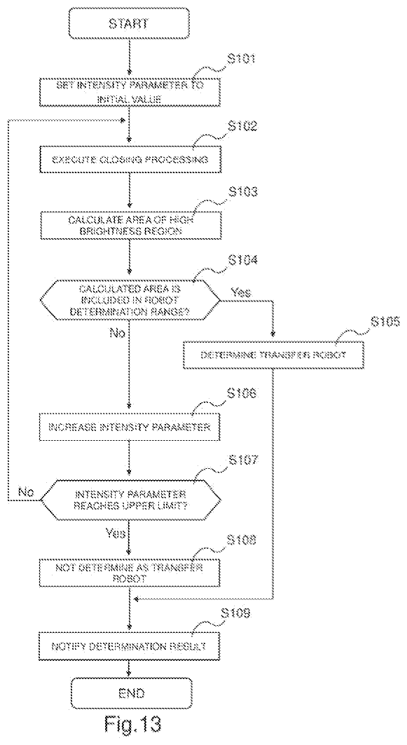

FIG. 13 is a flowchart illustrating an example of an operation of the robot detection section 311.

The robot detection section 311 sets an initial value of the intensity parameter (step S101). Here, a case that the number of dilation bits and the number of erosion bits are treated as the intensity parameters is described. The robot detection section 311 sets the initial values of the number of dilation bits and the number of erosion bits (for example, “1”). Note that as for determination on the parameter (determination on the initial value of the intensity parameter), the initial value may be determined by an administrator, or by the location information management apparatus 30. Alternatively, the initial value may be calculated on the basis of the accuracy of the camera, or a value with which the transfer robot 10 was detected at a certain time in the past was stored and the value stored at the certain time in the past (the value with which the transfer robot 10 was actually detected in the past) may be used as the initial value of the intensity parameter.

The robot detection section 311 executes the closing processing on the extracted high brightness image (step S102).

The robot detection section 311 calculates the area of the high brightness region in the image after the closing processing (step S103).

The robot detection section 311 determines whether or not the calculated area of the high brightness region is included in the robot determination range (step S104).

When the area of the high brightness region is included in the robot determination range (step S104, Yes branch), the robot detection section 311 determines that the high brightness image is the top panel of the transfer robot 10 (determining the transfer robot 10; step S105). In determining that the high brightness image is the top panel of the transfer robot 10, the robot detection section 311 executes a process in step S109.

When the area of the high brightness region is not included in the robot determination range (step S104, No branch), the robot detection section 311 increases the intensity parameter (step S106). For example, the robot detection section 311 increments the intensity parameters (the number of dilation bits and the number of erosion bits) to raise the noise removal capability of the closing processing by one level.

The robot detection section 311 determines whether or not the intensity parameter reaches a predefined upper limit (step S107).

When the intensity parameter does not reach the upper limit (step S107, No branch), the robot detection section 311 returns to step S102 to continue the processing. Note that the target image of the closing processing secondarily and subsequently performed is the image initially extracted by the robot detection section 311 (the high brightness image). In other words, the closing processing is not executed over the image on which the closing processing is completed. However, when the process in step S106 illustrated in FIG. 13 is not executed, the closing processing may be executed over the image on which the closing processing is completed. This is because a loop process in steps S102 to S107 except for step S106 illustrated in FIG. 13 is substantially equivalent to iterating the closing processing with the initial values of the intensity parameters (for example, the number of dilation bits and the number of erosion bits are 1).

When the intensity parameter reaches the upper limit (step S107, Yes branch), the robot detection section 311 does not determine that the high brightness image is the top panel of the transfer robot 10 (not determining as the transfer robot; step S108).

The robot detection section 311 notifies the robot location information generation section 312 of a determination result (whether or not the high brightness image corresponds to the top panel of the transfer robot 10) (step S109). Specifically, the robot detection section 311 notifies the robot location information generation section 312 of the image data acquired from the camera apparatus 20, an identifier (ID) of the transfer robot 10 and the location information of the transfer robot 10 (for example, the coordinates P1 to P4 in the example in FIG. 7).

In a case that one sheet of image data acquired from the camera apparatus 20 includes a plurality of high brightness images, the robot detection section 311 performs the determination processing on each high brightness image. In the example in FIG. 7, the high brightness image by the transfer robot 10-1 and the high brightness image by the transfer robot 10-2 are included in the image data, and thus, the robot detection section 311 executes the robot determination processing on each high brightness image.

Hereinafter, effects of the closing processing executed by the robot detection section 311 are specifically described.

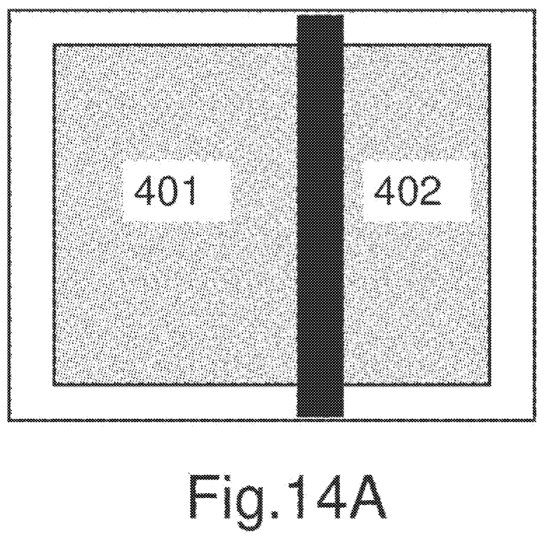

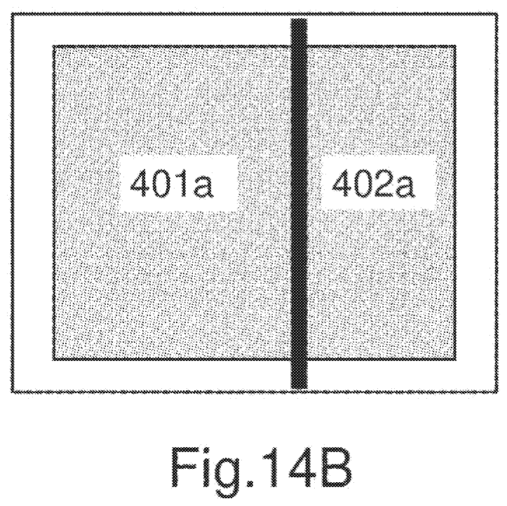

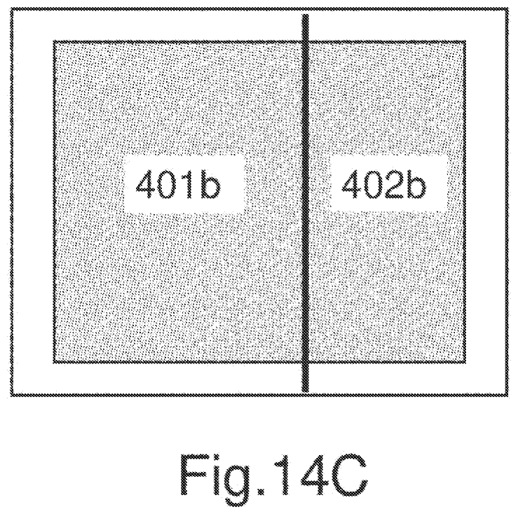

For example, assume a case that the robot detection section 311 extracts an image as illustrated in FIG. 14A. In this case, the robot detection section 311 calculates an area of the region 401 and the region 402 (a total value of areas of two regions) to determine whether or not the calculated area is included in the robot determination range.

In a case that the calculated area is smaller than the lower limit of the robot determination range, the robot detection section 311 executes the closing processing on the image illustrated in FIG. 14A. As a result, an image as illustrated in FIG. 14B is obtained. The robot detection section 311 calculates an area of a region 401a and a region 402a in FIG. 14B to determine whether or not the area is included in the robot determination range.

If the calculated area is not included in the robot determination range, the robot detection section 311 raises the intensity parameters by one level, and again executes the closing processing on the image illustrated in FIG. 14A. As a result, an image as illustrated in FIG. 14C is obtained. The robot detection section 311 calculates an area of a region 401b and a region 402b in FIG. 14C to determine whether or not the area is included in the robot determination range.

The robot detection section 311 iterates the processing as described above until the intensity parameter reaches the upper limit to determine whether or not the extracted high brightness image corresponds to the top panel of the transfer robot 10. The robot detection section 311 iterates the closing processing while raising the intensity parameters, which eventually can narrow a width of a black line of the image illustrated in FIG. 14A (the black line dividing the high brightness region) (or can decrease a region of the black line). As a result, the robot detection section 311 can accurately determine whether or not the high brightness image corresponds to the top panel of the transfer robot 10.

Note that the identifying (specifying) of the transfer robots 10 by the robot detection section 311 may be made by using a difference in the size of the light source attached to the top panel of each transfer robot 10 (the area of the high brightness region). For example, in the example in FIG. 7, the robot detection section 311 may identify two transfer robots 10 depending on whether the area of the high brightness region is included in the robot determination range of the transfer robot 10-1 or the robot determination range of the transfer robot 10-2.

Note that the method of identifying the transfer robot by using of the area of the high brightness region is merely an example, and another direction may be used. For example, a maker having an identification function such as a QR code (registered trademark) and an augmented reality (AR) marker may be attached to the transfer robot 10 so that the robot detection section 311 reads the marker to identify the transfer robot 10. Alternatively, the robot detection section 311 may transmit a specific signal or message to the transfer robot 10, and the transfer robot 10 receiving the signal or the like may respond an identification number or the like so that the transfer robot 10 is identified. In other words, even if identification information (for example, letters or markings) is not attached to the outside of the transfer robot 10, the robot detection section 311 can identify the transfer robot 10 owing to the signal or the like from the transfer robot 10.

The robot location information generation section 312 illustrated in FIG. 6 calculates an absolute position of the transfer robot 10 (the location in the field) and notifies the control apparatus 50 of the absolute position as the robot location information. Specifically, the robot location information generation section 312 converts the location of the transfer robot 10 in the image data (the number of pixels from the reference point) to the absolute position in the field on the basis of information of the camera apparatus 20 (a resolution of an imaging element or the like).

The robot location information generation section 312 converts the location of the transfer robot 10 (the number of pixels) from reference point (for example, lower left of the image) in the image data to the location (a relative position) with respect to the reference point of the image data in the field. The absolute position of the reference point in the field in the image data is known in advance, and thus, the robot location information generation section 312 adds the converted relative position to the absolute position of the reference point to calculate the absolute position of the transfer robot 10.

The robot location information generation section 312 transmits the identifier and absolute position of the detected transfer robot 10 to the control apparatus 50. Note that an absolute position of an object may be represented by four absolute coordinates forming the transfer robot 10, or absolute coordinates of one point representative of the transfer robot 10 (for example, the center of transfer robot 10).

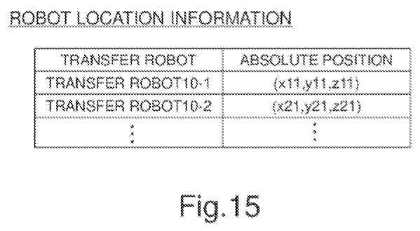

FIG. 15 is a diagram illustrating an example of the robot location information transmitted from the location information management apparatus 30. Note that an Internet protocol (IP) address of each transfer robot 10 or the like can be used as the identifier of the transfer robot 10.

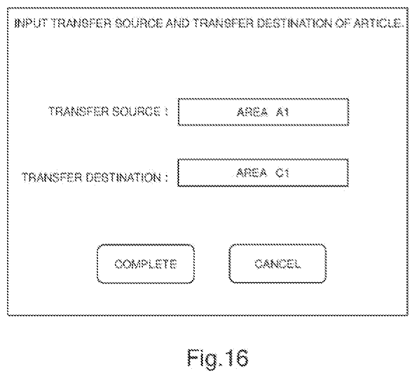

The terminal 40 generates the article transfer plan information described above. The terminal 40 displays a GUI for inputting the transfer source and the transfer destination of the article 60 on a liquid crystal display or the like. For example, the terminal 40 generates the GUI for inputting (specifying) the transfer source and the transfer destination of the article 60 as illustrated in FIG. 16, and provides the generated GUI to the operator. The terminal 40 transmits information input by the operator in accordance with the GUI to the control apparatus 50. Specifically, the terminal 40 transmits the transfer source and the transfer destination of the article 60 as the “article transfer plan information” to the control apparatus 50.

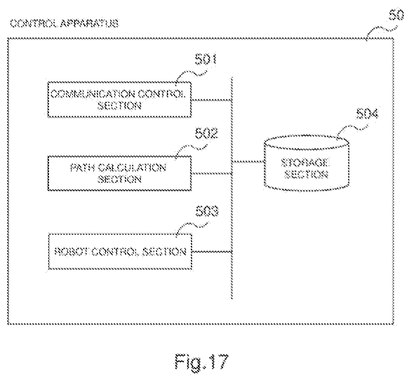

FIG. 17 is a diagram illustrating an example of a processing configuration (processing module) of the control apparatus 50 according to the first example embodiment. With reference to FIG. 17, the control apparatus 50 is configured to include a communication control section 501, a path calculation section 502, a robot control section 503, and a storage section 504.

The communication control section 501 controls communication with another apparatus, similar to the communication control section 301 in the location information management apparatus 30. The communication control section 501, in a case of acquiring the robot location information from the location information management apparatus 30 and acquiring the article transfer plan information from the terminal 40, stores these pieces of acquired information in the storage section 504.

The storage section 504 stores field configuration information indicating a configuration of the field, and robot management information for managing the information of the transfer robot 10. For example, the location information (the absolute positions in the field) of the transfer source and the transfer destination indicated in the article transfer plan information or the like are described in the field configuration information.

The path calculation section 502 is means for calculating a path on which the transfer robot pair transfers the article 60 from the transfer source to the transfer destination, on the basis of the article transfer plan information generated by the terminal 40.

The path calculation section 502 uses, for example, a path finding algorithm such as the Dijkstra method or the Bellman-Ford method to calculate the path for transferring the article 60 from the transfer source to the transfer destination. Note that the path finding algorithm such as the Dijkstra method is obvious to those of ordinary skill in the art, and thus, the detailed description thereof is omitted.

The robot control section 503 is means for controlling the transfer robot 10. The robot control section 503 transmits to the transfer robots 10 the control information for the transfer robot pair to transfer the article 60 on the basis of the location information of the transfer robot 10 and the location information of the other transfer robot 10 paired with the transfer robot 10. The robot control section 503 transmits the control command (control information) to the transfer robot 10 to control the transfer robot 10.

The robot control section 503 grasps the absolute position of the transfer robot 10 in the field by using the robot location information notified from the location information management apparatus 30. The robot control section 503 needs information relating to an orientation of the transfer robot 10 when controlling the transfer robot 10. In this case, a gyroscope sensor or the like may be attached to the transfer robot 10 so that the robot control section 503 may acquire the information relating to the orientation from the transfer robot 10. Alternatively, the orientation when the transfer robot 10 is initially placed in the field may be predefined so that the orientation of the transfer robot 10 may be estimated on the basis of the control command transmitted from the robot control section 503 to the transfer robot 10.

The robot control section 503 transmits the control command to the transfer robots 10 to control two transfer robots 10 so as to hold therebetween the article 60 placed at the transfer source. Specifically, the robot control section 503 moves two transfer robots 10 such that the robots oppose each other across the article 60 and a distance between the robots becomes narrower.

After that, the robot control section 503 generates the control command such that the transfer robot pair holding the article 60 therebetween moves on the path calculated as the transfer path for the transfer robot pair, and transmits the generated control command to each transfer robot 10.

The robot control section 503 treats one of two transfer robots 10 as a “leading transfer robot” and the other as a “following transfer robot”. As such, the robot control section 503 acquires a current location of the leading transfer robot 10 of the transfer robots 10 described in the robot management information. Next, the robot control section 503 determines a location to be reached by the leading transfer robot 10 on the basis of the transfer path calculated by the path calculation section 502.

In a case that the transfer robot pair is made to go straight, the robot control section 503 calculates a time and speed at which a motor of each transfer robot 10 is rotated depending on a distance between the current location of the leading transfer robot 10 and the calculated location to be reached. At this time, the robot control section 503 generates the control command such that the motor rotation speeds of the respective transfer robots 10 are the same.

In a case that the transfer robot pair is made to go round, the robot control section 503 uses a model of circular motion of moving in a curve due to a difference in speed between right and left wheels. Specifically, the robot control section 503 calculates input speeds to the right and left wheels for reaching a target location from the current location in a circular orbit on the basis of the target location, and the orientation and location of the robot. The robot control section 503 uses the calculated input speed without change for the leading transfer robot 10 to generate a control command transmitted to the leading transfer robot 10 on the basis of the calculated input speed. In contrast, the robot control section 503 calculates, for the following transfer robot 10, a speed correction value in a front-back direction based on the distance between the robots (the distance between plates of the transfer robots holding the article 60 therebetween) and an offset correction value for the right and left wheels based on an angle of rotation. The robot control section 503 generates a control command transmitted to the following transfer robot 10 on the basis of these correction values (speed correction value, and offset correction value).

In a case that the transfer robot pair reaches the transfer destination, the robot control section 503 controls the transfer robot pair so as to put the article 60 at the transfer destination. Specifically, the robot control section 503 controls such that the distance between two transfer robots 10 becomes longer to complete the transfer of the article 60.

As described above, in the transfer system according to the first example embodiment, the location information management apparatus 30 calculates the location of the moving object (transfer robot 10) in the field from the image acquired from the camera apparatus 20. The location information management apparatus 30 executes the image processing on the high brightness image, and determines whether or not the moving object is included in the image acquired from the camera apparatus 20 in accordance with the area of the high brightness region included in the image after executing the image processing. To be more specific, the location information management apparatus 30 executes the closing processing on the high brightness image (the first image), and detects the presence of the moving object based on the image (a second image) obtained as a result of the closing processing.

As described with reference to FIG. 12, the closing processing is executed to remove the noise in the image. In the example illustrated in FIG. 14A, the black line separating the two high brightness regions corresponds to noise, and the black line is removed. The location information management apparatus 30 can determine whether or not the image after the noise (black line) is removed corresponds to the top panel of the transfer robot 10 to accurately identify (detect) the transfer robot 10 transferring the article 60 loaded on the tall basket cart or the like.

### Second Example Embodiment

Subsequently, a second example embodiment is described in detail with reference to the drawings.

In the first example embodiment, the closing processing is executed while sequentially raising the intensity parameters. The second example embodiment describes a case that the intensity parameters suitable for the extracted high brightness image are calculated in advance to execute the closing processing using the intensity parameters.

Note that a configuration of the location information management apparatus 30 according to the second example embodiment can be similar to the first example embodiment, and thus, a description corresponding to FIG. 5 is omitted. Hereinafter, differences from the first embodiment will be mainly described.

The robot detection section 311 according to the second example embodiment calculates, when a plurality of high brightness regions are included in one high brightness image, the shortest distance between the plurality of high brightness regions to determine intensity parameters depending on the shortest distance. For example, in the example in FIG. 9, the shortest distance between the region 401 and the region 402 is calculated to determine the intensity parameters depending on the distance.

For example, the robot detection section 311 extracts an edge of each of the high brightness regions. The robot detection section 311 calculates a distance between a pixel in one high brightness region (a pixel on the extracted edge) and a pixel in the other high brightness region (a pixel on the extracted edge). For example, the robot detection section 311 fixes the pixel in one high brightness region to calculate a distance between the fixed pixel and each of pixels on the corresponding edge in the other high brightness region. Next, the robot detection section 311 moves the fixed pixel to another pixel on the edge, and then, similar to the above, calculates a distance between the fixed pixel and each of pixels on the corresponding edge in the other high brightness region. The robot detection section 311 iterates the processing as described above until the fixed pixel goes full circle on the edge, and selects the minimum value among the calculated distances to calculate the shortest distance between the high brightness regions.

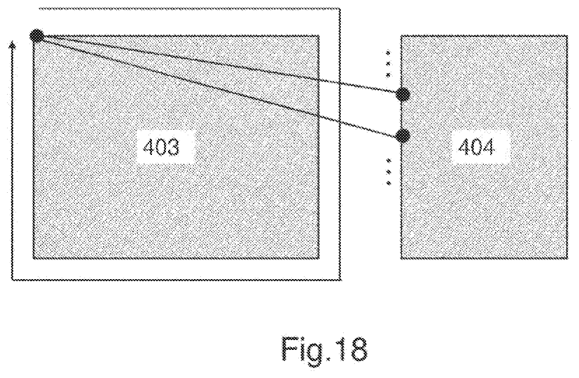

For example, assume a case that, as illustrated in FIG. 18, two regions 403 and 404 are extracted as the high brightness regions. In this case, the robot detection section 311 fixes a pixel on an edge of the region 403, and calculates a distance between the fixed pixel and each of pixels on an edge of the region 404. Next, the robot detection section 311 changes a calculation target by moving the fixed pixel to another pixel on the edge of the region 403, and again, calculates a distance to each of pixels on the edge of the region 404. The robot detection section 311 calculates a minimum value of the distances calculated by such processing as the shortest distance between the high brightness regions.

Note that also in a case that three or more high brightness regions are included in one high brightness image, the shortest distance between the high brightness regions can be similarly calculated.

The robot detection section 311 determines the intensity parameters used for the closing processing depending on the calculated shortest distance. For example, the robot detection section 311 sets the number of pixels of the shortest distance as the number of dilation bits (the number of dilation pixels) and the number of erosion bits (the number of erosion pixels). Alternatively, the robot detection section 311 may set the number of pixels of the shortest distance as the iteration number.

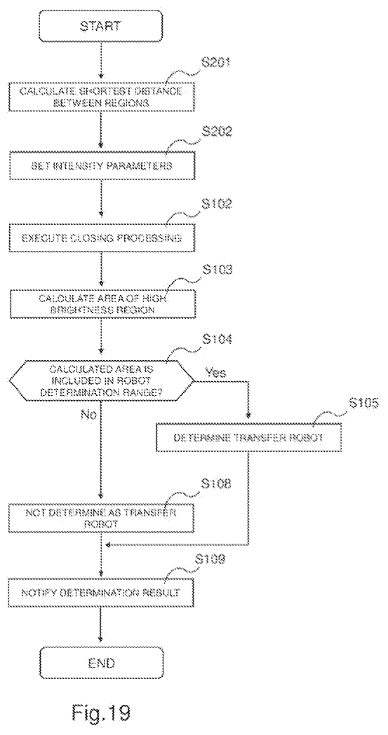

FIG. 19 is a flowchart illustrating an example of an operation of the robot detection section 311 according to the second example embodiment. Note that in the flowcharts illustrated in FIG. 13 and FIG. 19, the processes that can be the same in the content are designated by the same reference sign (step name), and the detailed description thereof is omitted.

The robot detection section 311 calculates the shortest distance between the high brightness regions (step S201).

The robot detection section 311 sets the intensity parameters depending on the calculated shortest distance (step S202).

After that, the robot detection section 311 determines whether or not an area of the high brightness region is included in the robot determination range by one time of the closing processing. Specifically, the robot detection section 311 according to the second example embodiment determines whether or not the high brightness image is an image corresponding to the top panel of the transfer robot 10, where the iteration numbers of varying the intensity parameters and executing the closing processing can be reduced compared to the first example embodiment,

As described above, the location information management apparatus 30 according to the second example embodiment, in the case that a plurality of high brightness regions are included in one high brightness image, calculates the shortest distance between the plurality of high brightness regions to determine the intensity parameters depending on the shortest distance. As a result, the number of times iterating the intensity parameters varying and the closing processing that are required in the first example embodiment can be reduced, and the load on the location information management apparatus 30 can be reduced.

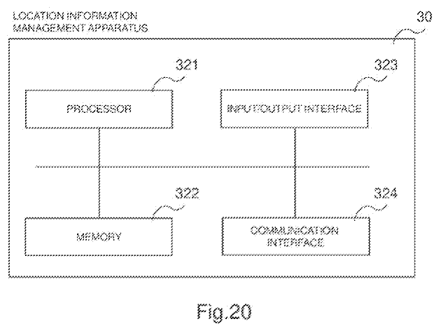

Next, hardware of each apparatus configuring the transfer system will be described. FIG. 20 is a diagram illustrating an example of a hardware configuration of the location information management apparatus 30.

The location information management apparatus 30 can be configured with an information processing apparatus (so-called, a computer), and includes a configuration illustrated in FIG. 20. For example, the location information management apparatus 30 includes a processor 321, a memory 322, an input/output interface 323, a communication interface 324, and the like. Constituent elements such as the processor 321 are connected to each other with an internal bus or the like, and are configured to be capable of communicating with each other.

However, the configuration illustrated in FIG. 20 is not to intended to limit the hardware configuration of the location information management apparatus 30. The location information management apparatus 30 may include hardware not illustrated, or may not include the input/output interface 323 as necessary. The number of processors 321 and the like included in the location information management apparatus 30 is not intended to be limited to the example illustrated in FIG. 20, and for example, a plurality of processors 321 may be included in the location information management apparatus 30.

The processor 321 is, for example, a programmable device such as a central processing unit (CPU), a micro processing unit (MPU), and a digital signal processor (DSP). Alternatively, the processor 321 may be a device such as a field programmable gate array (FPGA) and an application specific integrated circuit (ASIC). The processor 321 executes various programs including an operating system (OS).

The memory 322 is a random access memory (RAM), a read only memory (ROM), a hard disk drive (HDD), a solid state drive (SSD), or the like. The memory 322 stores an OS program, an application program, and various pieces of data.

The input/output interface 323 is an interface of a display apparatus and an input apparatus (not illustrated). The display apparatus is, for example, a liquid crystal display or the like. The input apparatus is, for example, an apparatus that receives user operation, such as a keyboard and a mouse.

The communication interface 324 is a circuit, a module, or the like that performs communication with another apparatus. For example, the communication interface 324 includes a network interface card (MC), a radio communication circuit, or the like.

The function of the location information management apparatus 30 is implemented by various processing modules. Each of the processing modules is, for example, implemented by the processor 321 executing a program stored in the memory 322. The program can be recorded on a computer readable storage medium. The storage medium can be a non-transitory storage medium, such as a semiconductor memory, a hard disk, a magnetic recording medium, and an optical recording medium. In other words, the present invention can also be implemented as a computer program product. The program can be updated through downloading via a network, or by using a storage medium storing a program. In addition, the processing module may be implemented by a semiconductor chip.

Note that the terminal 40, the control apparatus 50, and the like also can be configured by the information processing apparatus similar to the location information management apparatus 30, and their basic hardware structures are not different from the location information management apparatus 30, and thus, the descriptions thereof are omitted.

### Example Alterations

Note that the configuration, the operation, and the like of the transfer system described in the example embodiments are merely examples, and are not intended to limit the configuration and the like of the system.

In the example embodiments, the transfer robot 10 is used as an example of the moving object, but moving object to which the disclosure of the present application can be applied is not limited to the transfer robot 10. For example, by applying the disclosure of the present application, a location of the operator or the like working in the field may be specified.

For example, the example embodiments describe the case that the transfer robot pair consisting of two transfer robots 10 transfers the article 60, but one transfer robot may be used. In other words, a transfer robot of related art (for example, a robot of a type that the robot itself is loaded with the article 60, a robot of a type being robot with the article 60 by traction equipment) may be used to transfer the article 60. In this case, the control apparatus 50 may control one transfer robot on the basis of the article transfer plan information acquired from the terminal 40 or the like, and thus, the article 60 can be transferred by easier control. Alternatively, the number of transfer robots 10 to be controlled by the control apparatus 50 may be three or more. Increase in the number of transfer robots 10 allows a smaller (more inexpensive) transfer robot 10 to be used to transfer a weightier article 60 or the like.

The example embodiments describe that the closing processing is used as the image processing for noise removal, but another processing may be used. For example, a Gaussian filter also referred to as “Gaussian blur” may be used. In this case, the location information management apparatus 30 applies the Gaussian filter to the high brightness image, and detects the presence of the transfer robot 10 based on an image obtained by applying the Gaussian filter. At this time, the location information management apparatus 30 calculates the area of the high brightness region to try to detect the transfer robot 10 while sequentially raising a parameter defining an intensity of the Gaussian filter.

Alternatively, the location information management apparatus 30 may apply a lowpass filter to the high brightness image, and detect the transfer robot 10 based on an image obtained through the filter. As illustrated in FIG. 7, when the area of the light source disposed on the top panel of the transfer robot 10 is large, the lowpass filter can be applied to the high brightness image to remove fine noises.

The location information management apparatus 30 may execute prescribed image processing before the image processing such as the closing processing. For example, the location information management apparatus 30 may execute geometric transformation such as affine transformation or density conversion for converting a contrast as necessary.

The example embodiments mainly describe the number of dilation bits and the number of erosion bits by the examples as the parameters defining the intensity of the closing processing, but the parameters may be the iteration numbers of each of the dilation processing and the erosion processing.

The location information management apparatus 30 may linearly (straight linearly) vary the intensity parameter, or may non-linearly vary the intensity parameter in a manner of an exponential function. Specifically, the location information management apparatus 30, when iteratively executing the closing processing or the like, may vary the parameter so that the noise removal capability is rapidly improved as the number of iterations increases.

In the closing processing according to the example embodiments, a cross-shaped dilation from the pixel of interest is described. However, the dilation processing is not limited the cross-shaped dilation, and the dilation may be made such that the brightness values of all or some of pixels positioned around the pixel of interest are changed. For example, the brightness values of the pixels including those on the upper left or the like of the pixel of interest can be converted. Alternatively, in the dilation processing and the erosion processing, the number of set pixels may be changed in a lateral direction or a longitudinal direction. For example, the number of pixels may be set in a lateral and longitudinal asymmetric manner with dilation by two pixels in the longitudinal direction and dilation by one pixel in the lateral direction.

The example embodiments describe the case that the transfer robot 10 is identified using the area of the light source, but the transfer robot 10 may be identified depending on an intensity of the light source arranged at the transfer robot 10 (the brightness on the image). For example, in the example in FIG. 7, intensity from the light source of the transfer robot 10-1 and intensity from the light source of the transfer robot 10-2 may be differentiated to distinguish these transfer robots 10. Specifically, even when the sizes (the areas of the high brightness regions) of the light sources disposed at two respective transfer robots 10 are the same, two transfer robots 10 can be distinguished by differentiating the respective light sources. Alternatively, a difference in colors of the light sources may be used to distinguish two transfer robot 10.

Depending on conditions in the field, the light source may not be needed by whitening the top panel of the transfer robot 10 and so on.

The example embodiments are described on the assumption that the location information management apparatus 30 and the control apparatus 50 are separate apparatuses, but the functions of the location information management apparatus 30 may be implemented by the control apparatus 50. Alternatively, the location information management apparatus 30 may be installed in the field, and the control apparatus 50 may be mounted on a server on the network. In other words, the transfer system according to the disclosure of the present application may be realized as an edge cloud system.

The example embodiments describe the case that the camera capable of detecting the distance between the ceiling and the transfer robot 10 (for example, a stereo camera) is used. However, both a normal camera, and a sensor for measuring a distance between the normal camera and the transfer robot 10 (for example, an infrared sensor, a range sensor) may be used.

By installing a location specifying program in a storage section of a computer, the computer can be caused to function as the location information management apparatus 30. By causing the computer to execute the location specifying program, a location specifying method can be executed by the computer.

In a plurality of flowcharts used in the above description, a plurality of steps (processes) are described in order, but the order of performing of the steps performed in each example embodiment is not limited to the described order. In each example embodiment, the illustrated order of processes can be changed as far as there is no problem with regard to processing contents, such as a change in which respective processes are executed in parallel, for example.

The example embodiments can be combined within a scope that the contents do not conflict. For example, the number of bits of the shortest distance calculated in the second example embodiment may be set as the initial values of the number of dilation bits and the number of erosion bits.

Although the industrial applicability of the present invention is apparent from the description above, the present invention can be preferably applied to article transfer in a factory, a distribution warehouse, or the like.

The whole or part of the example embodiments disclosed above can be described as in the following supplementary notes, but are not limited to the following.

### (Supplementary Note 1)

A system including:

a moving object (10, 101) equipped with a top panel (112) on which a light emitting part (111) is disposed; and

a location information management apparatus (30, 102) configured to extract a first image including the light emitting part (111) from an image in which the moving object (10, 101) is captured, execute image processing on the first image to detect a presence of the moving object (10, 101), and specify a location of the moving object (10, 101).

### (Supplementary Note 2)

The system according to supplementary note 1, wherein the image processing is processing for removing noise included in a region corresponding to the light emitting part (111) of the first image.

### (Supplementary Note 3)

The system according to supplementary note 1 or 2, wherein the location information management apparatus (30, 102) is configured to vary a parameter that defines a noise removal capability of the image processing, calculate an area of the light emitting part (111) included in the first image for each varied parameter, and detect the presence of the moving object (10, 101) based on the calculated area.

### (Supplementary Note 4)

The system according to supplementary note 1 or 2, wherein the location information management apparatus (30, 102) is configured to, when a plurality of regions corresponding to the light emitting part (111) are included in the first image, determine a parameter that defines a noise removal capability of the image processing based on a distance between the plurality of regions, and execute the image processing using the determined parameter.

### (Supplementary Note 5)

The system according to any one of supplementary notes 1 to 4, wherein the location information management apparatus (30, 102) is configured to execute closing processing on the first image, and detect the presence of the moving object (10, 101) based on a second image obtained as a result of the closing processing.

### (Supplementary Note 6)

The system according to any one of supplementary notes 1 to 4, wherein the location information management apparatus (30, 102) is configured to apply a Gaussian filter to the first image and detect the presence of the moving object (10, 101) based on a second image obtained by applying the Gaussian filter.

### (Supplementary Note 7)

A location information management apparatus (30, 102) configured to extract, from an image in which a moving object (10, 101) is captured, the moving object being equipped with a top panel (112) on which a light emitting part (111) is disposed, a first image including the light emitting part (111), execute image processing on the first image to detect a presence of the moving object (10, 101), and specify a location of the moving object (10, 101).

### (Supplementary Note 8)

The location information management apparatus (30, 102) according to supplementary note 7, wherein the image processing is processing for removing noise included in a region corresponding to the light emitting part (111) of the first image.

### (Supplementary Note 9)

The location information management apparatus (30, 102) according to supplementary note 7 or 8, wherein the location information management apparatus is configured to vary a parameter that defines a noise removal capability of the image processing, calculate an area of the light emitting part (111) included in the first image for each varied parameter, and detect the presence of the moving object (10, 101) based on the calculated area.

### (Supplementary Note 10)

The location information management apparatus (30, 102) according to supplementary note 7 or 8, wherein the location information management apparatus is configured to determine, when a plurality of regions corresponding to the light emitting part (111) are included in the first image, a parameter that defines a noise removal capability of the image processing based on a distance between the plurality of regions, and execute the image processing using the determined parameter.

### (Supplementary Note 11)

The location information management apparatus (30, 102) according to any one of supplementary notes 7 to 10, wherein the location information management apparatus is configured to execute closing processing on the first image, and detect the presence of the moving object (10, 101) based on a second image obtained as a result of the closing processing.

### (Supplementary Note 12)

The location information management apparatus (30, 102) according to any one of supplementary notes 7 to 10, wherein the location information management apparatus is configured to apply a Gaussian filter to the first image and detect the presence of the moving object (10, 101) based on a second image obtained by applying the Gaussian filter.

### (Supplementary Note 13)

A location specifying method in a location information management apparatus (30, 102), the location specifying method including:

extracting, from an image in which a moving object (10, 101) is captured, the moving object being equipped with a top panel (112) on which a light emitting part (111) is disposed, a first image including the light emitting part (111);

executing image processing on the first image to detect a presence of the moving object (10, 101); and

specifying a location of the moving object (10, 101).

### (Supplementary Note 14)

The location specifying method according to supplementary note 13, wherein the image processing is processing for removing noise included in a region corresponding to the light emitting part (111) of the first image.

### (Supplementary Note 15)

The location specifying method according to supplementary note 13 or 14, wherein the detecting the presence of the moving object (10, 101) includes varying a parameter that defines a noise removal capability of the image processing, calculating an area of the light emitting part (111) included in the first image for each varied parameter, and detecting the presence of the moving object (10, 101) based on the calculated area.

### (Supplementary Note 16)

The location specifying method according to supplementary note 13 or 14, wherein the detecting the presence of the moving object (10, 101) includes determining, when a plurality of regions corresponding to the light emitting part (111) are included in the first image, a parameter that defines a noise removal capability of the image processing based on a distance between the plurality of regions, and executing the image processing using the determined parameter.

### (Supplementary Note 17)

The location specifying method according to any one of supplementary notes 13 to 16, wherein the detecting the presence of the moving object (10, 101) includes executing closing processing on the first image, and detecting the presence of the moving object (10, 101) based on a second image obtained as a result of the closing processing.

### (Supplementary Note 18)

The location specifying method according to any one of supplementary notes 13 to 16, wherein the detecting the presence of the moving object (10, 101) includes applying a Gaussian filter to the first image and detecting the presence of the moving object (10, 101) based on a second image obtained by applying the Gaussian filter.

### (Supplementary Note 19)

A program causing a computer (321) mounted on a location information management apparatus (30, 102) to execute:

extracting, from an image in which a moving object (10, 101) is captured, the moving object being equipped with a top panel (112) on which a light emitting part (111) is disposed, a first image including the light emitting part (111);

executing image processing on the first image to detect a presence of the moving object (10, 101); and

specifying a location of the moving object (10, 101).

### (Supplementary Note 20)

A system including:

a moving object (10, 101) equipped with a light emitting part (111);

a camera apparatus (20) configured to capture an image of a field including the moving object (10, 101); and

a location information management apparatus (30, 102) configured to calculate a location of the moving object (10, 101) in the field by using an image acquired from the camera apparatus (20), wherein

the location information management apparatus (30, 102) is configured to extract a high brightness image including at least one or more high brightness regions, the high brightness region being a set of pixels, each pixel having a brightness value equal to or more than a prescribed value among a plurality of pixels constituting the image acquired from camera apparatus (20), execute image processing on the high brightness image, and determine whether the moving object (10, 101) is included in the image acquired from the camera apparatus (20) in accordance with an area of the high brightness region included in the image after executing the image processing.

### (Supplementary Note 21)

The system according to supplementary note 20, wherein the location information management apparatus (30, 102) is configured to execute closing processing as the image processing.

### (Supplementary Note 22)

The system according to supplementary note 21, wherein the location information management apparatus (30, 102) is configured to execute the closing processing while varying a parameter defining an intensity of the closing processing.

### (Supplementary Note 23)

The system according to supplementary note 22, wherein the location information management apparatus (30, 102) is configured to calculate, in a case that a plurality of high brightness regions are included in the high brightness image, a shortest distance between the plurality of high brightness regions to determine the parameter in accordance with the shortest distance.

Note that the disclosures of the cited literatures in the citation list are incorporated by reference. Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

This application claims priority based on JP 2019-153966 filed on Aug. 26, 2019, the entire disclosure of which is incorporated herein.

### REFERENCE SIGNS LIST

10, 10-1, 10-2 Transfer Robot
20 Camera Apparatus
30, 102 Location Information Management Apparatus
40 Terminal
50 Control Apparatus
60 Article
101 Moving Object
111 Light Emitting Part
112 Top Panel
201, 301, 501 Communication Control Section
202 Actuator Control Section
302 Location Information Generation Section
303, 504 Storage Section
311 Robot Detection Section
312 Robot Location Information Generation Section
321 Processor
322 Memory
323 Input/Output Interface
324 Communication Interface
401, 401a, 401b, 402, 402a, 402b, 403, 404 Region
502 Path Calculation Section
503 Robot Control Section

What is claimed is:

1. A system comprising:
a moving object equipped with a top panel on which a light emitting part is disposed; and
a location information management apparatus comprising a memory storing instructions, and one or more processors, wherein
the one or more processors are configured to execute the instructions to
extract a first image including the light emitting part from an image in which the moving object is captured,
execute image processing on the first image to detect a presence of the moving object, and
specify a location of the moving object.

2. The system according to claim 1, wherein the image processing is processing for removing noise included in a region corresponding to the light emitting part of the first image.

3. The system according to claim 1, wherein the one or more processors are configured to vary a parameter that defines a noise removal capability of the image processing, calculate an area of the light emitting part included in the first image for each varied parameter, and detect the presence of the moving object based on the calculated area.

4. The system according to claim 1, wherein the one or more processors are configured to, when a plurality of regions corresponding to the light emitting part are included in the first image, determine a parameter that defines a noise removal capability of the image processing based on a distance between the plurality of regions, and execute the image processing using the determined parameter.

5. The system according to claim 1, wherein the one or more processors are configured to execute closing processing on the first image, and detect the presence of the moving object based on a second image obtained as a result of the closing processing.

6. The system according to claim 1, wherein the one or more processors are configured to apply a Gaussian filter to the first image and detect the presence of the moving object based on a second image obtained by applying the Gaussian filter.

7. A location information management apparatus comprising:
a memory storing instructions; and
one or more processors configured to execute the instructions to:
extract, from an image in which a moving object is captured, the moving object being equipped with a top panel on which a light emitting part is disposed, a first image including the light emitting part,
execute image processing on the first image to detect a presence of the moving object, and
specify a location of the moving object.

8. The location information management apparatus according to claim 7, wherein the image processing is processing for removing noise included in a region corresponding to the light emitting part of the first image.

9. The location information management apparatus according to claim 7, wherein the one or more processors are configured to vary a parameter that defines a noise removal capability of the image processing, calculate an area of the light emitting part included in the first image for each varied parameter, and detect the presence of the moving object based on the calculated area.

10. The location information management apparatus according to claim 7, the one or more processors are configured to determine, when a plurality of regions corresponding to the light emitting part are included in the first image, a parameter that defines a noise removal capability of the image processing based on a distance between the plurality of regions, and execute the image processing using the determined parameter.

11. The location information management apparatus according to claim 7, wherein the one or more processors are configured to execute closing processing on the first image, and detect the presence of the moving object based on a second image obtained as a result of the closing processing.

12. The location information management apparatus according to claim 7, wherein the one or more processors are configured to apply a Gaussian filter to the first image and detect the presence of the moving object based on a second image obtained by applying the Gaussian filter.

13. A location specifying method in a location information management apparatus, the location specifying method comprising:
extracting, from an image in which a moving object is captured, the moving object being equipped with a top panel on which a light emitting part is disposed, a first image including the light emitting part;
executing image processing on the first image to detect a presence of the moving object; and
specifying a location of the moving object.

14. The location specifying method according to claim 13, wherein the image processing is processing for removing noise included in a region corresponding to the light emitting part of the first image.

15. The location specifying method according to claim 13, wherein the detecting the presence of the moving object includes varying a parameter that defines a noise removal capability of the image processing, calculating an area of the light emitting part included in the first image for each varied parameter, and detecting the presence of the moving object based on the calculated area.

16. The location specifying method according to claim 13, wherein the detecting the presence of the moving object includes determining, when a plurality of regions corresponding to the light emitting part are included in the first image, a parameter that defines a noise removal capability of the image processing based on a distance between the plurality of regions, and executing the image processing using the determined parameter.

17. The location specifying method according to claim 13, wherein the detecting the presence of the moving object includes executing closing processing on the first image, and detecting the presence of the moving object based on a second image obtained as a result of the closing processing.

18. The location specifying method according to claim 13, wherein the detecting the presence of the moving object includes applying a Gaussian filter to the first image and detecting the presence of the moving object based on a second image obtained by applying the Gaussian filter.

19-23. (canceled)
